(19) United States
(12) Patent Application Publication
(10) Pub. No.: US 2026/0010874 A1
(43) Pub. Date: Jan. 8, 2026

(54) EXPECTATION DRIVEN CANDIDATE-EMPLOYER MATCHING FOR HIRING ENGAGEMENT COORDINATION

(71) Applicant: JobCommander, Inc., BOCA RATON, FL (US)

(72) Inventors: Christopher Izmirlian, Delray Beach, FL (US); Sonia Izmirlian, HIGHLAND BEACH, FL (US); Charles Izmirlian, HIGHLAND BEACH, FL (US)

(73) Assignee: JobCommander, Inc., BOCA RATON, FL (US)

(21) Appl. No.: 18/764,108

(22) Filed: Jul. 3, 2024

(51) Int. Cl. G06Q 10/1053

(52) U.S. Cl. CPC G06Q 10/1053

(57) ABSTRACT

Candidate filtering for electronic matching of job candidates for job interviewing includes configuring a set of markup language documents to include a random selection of questions retrieved from a repository of questions and transmitting the documents to a remote browser of a job candidate. Response strings corresponding to answers to the random selection of questions are then received and immutably stored in association with a profile of the job candidate. Thereafter, candidate filtering compares the answers in combination with the profile to corresponding answers of different employers and respective profiles of the different employers to compute a compatibility value for each different employer based upon portions of the immutably stored answers and of the profile matching. Finally, candidate matching initiates mediated messaging between a communications client of the job candidate and at least one of the different employers having a computed compatibility value at or above a minimum threshold.

### BACKGROUND OF THE INVENTION

### Field of the Invention

The present invention relates to the technical field of online job candidate matching and more particularly to the automated initiation of job candidate to prospective employer digital communications responsive to a computed compatibility.

### Description of the Related Art

Online job matching systems have revolutionized how job seekers and employers connect. These platforms use algorithms to sift through a myriad of data, such as employee skills, experience, and preferences, to match candidates with jobs. By analyzing resumes, job descriptions, and user behavior, these systems can identify potential matches, significantly optimizing the tedious search process for both job seekers and hiring managers. This efficiency is crucial, as quick and accurate hiring practices can be the difference between securing top talent or top job opportunities and losing them to competitors on both sides.

The operation of these digital platforms involves several key components. Job seekers create profiles similar to resumes, including their experience, education, skills, and other relevant information, and may be assigned logic quizzes or field-relevant tests. Employers create profiles and detailed job listings for the roles they need to fill, specifying the necessary qualifications and other pertinent information. The platform's algorithm then compares candidate profiles with job listings, taking into account keywords, qualifications, and geographic location. In recent years, machine learning has also been employed to improve the accuracy of job matching based on previous outcomes.

Despite their benefits, these digital job markets are not without their flaws. One significant issue is that the reliance on algorithms can sometimes lead to over-filtering, where potentially suitable candidates are overlooked because their resumes and/or profiles do not have the exact keywords the algorithm is programmed to identify. This is particularly troublesome for non-traditional candidates with unique skills that don't necessarily fit the predefined categories but can offer a valuable perspective. Furthermore, some job seekers may try to take advantage of the algorithm by filling their resumes with such keywords, resulting in less true matches for employers.

Moreover, the impersonal nature of automated matching can make the job search experience feel less human. Treating candidates and recruiters as mere sets of numbers can lead to a lack of personal connection, making it difficult to assess compatibility in character and values, which are crucial to building a strong work relationship. This reduction of human elements in the hiring process can result in misaligned expectations and decreased job satisfaction, as neither party has a full understanding of the other's personality, work style, personal beliefs or company culture. Consequently, even if the technical qualifications match perfectly, the absence of a personal compatibility can significantly hinder the success of the match.

Therefore, while online job markets offer efficiency and reach, it is essential to address these limitations, thus helping the demand of job seekers and the supply of recruiters reach an equilibrium.

### BRIEF SUMMARY OF THE INVENTION

Embodiments of the present invention address technical deficiencies of the art in respect to online job candidate matching to prospective employers. To that end, embodiments of the present invention provide for a novel and non-obvious method for candidate filtering for electronic matching of job candidates for job interviewing. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a candidate filtering method for electronic matching of job candidates for job interviewing includes configuring a set of markup language documents to include a random selection of questions retrieved from a repository of questions. The method additionally includes transmitting the set of markup language documents to a remote browser of a job candidate and receiving in response to the transmission, response strings corresponding to answers to the random selection of questions. The method yet further includes immutably storing the answers in the response strings in association with a profile of the job candidate. Finally, the method includes comparing the immutably stored answers in combination with the profile to corresponding answers of different employers and respective profiles of the different employers, computing a compatibility value for each one of the different employers based upon portions of the immutably stored answers and of the profile matching which match respective portions of the corresponding answers and profiles of the different employers and initiating mediated messaging between a communications client of the job candidate and at least one of the different employers having a computed compatibility value at or above a minimum threshold.

Aspects of the embodiment include different optional variations such as the following exemplary variations:
Data in the profile of the job candidate can be changed by the job candidate through the browser in order to change the computation of the compatibility for each one of the different employers.
Mediated messaging can be initiated with one of the different employers having a computed compatibility value at or above the minimum threshold, but within a deviation value of the minimum threshold.
During computation of the compatibility value, a comparison can be weighted of one of the immutably stored answers based upon a speed at which the job candidate had provided the one of the immutably stored answers responsive to a presentation of a corresponding one of the random selection of questions.
A what-if analysis can be performed by changing at least one portion of the profile of the job candidate in order to produce a compatibility value for a specific one of the different employers and then a markup language artifact can be transmitted to the remote browser presenting the changed at least one portion of the profile.

In another embodiment of the invention, a data processing system is adapted for candidate filtering in the electronic matching of job candidates for job interviewing. The system includes a host computing platform of one or more computers, each with memory and one or more processing units including one or more processing cores. The system also includes a Web server executing in the computers and receiving request strings from over a data communications network and responding to the request strings over the data communications network with a transmission of specific ones of markup language documents. The system further includes a messaging platform receiving messages and delivering message between different messaging subscribers from over the data communications network. The system even further includes a database coupled to the platform and providing a repository of question stored therein as different records comprising the questions.

Finally, the system includes a candidate filtering module including computer program instructions enabled while executing in the memory of at least one of the processing units of the host computing platform to perform the aforementioned candidate filtering. Specifically, the program instructions perform the candidate filtering by configuring a set of the markup language documents in the Web server to include a random selection of questions retrieved from the repository of questions. The program instructions additionally direct the Web server to transmit the set of markup language documents over the data communications network to a remote browser of a job candidate and then to receive from over the data communications network in response to the transmission, response strings corresponding to answers to the random selection of questions. The program instructions yet further immutably store in the memory the answers in the response strings in association with a profile of the job candidate.

Thereafter, the program instructions compare the immutably stored answers in the memory in combination with the profile to corresponding answers of different employers and respective profiles of the different employers. Finally, the program instructions compute by the one or more of the processing units a compatibility value for each one of the different employers based upon portions of the immutably stored answers and of the profile matching which match respective portions of the corresponding answers and profiles of the different employers and initiate mediated messaging in the messaging platform between a communications client of the job candidate and at least one of the different employers having a computed compatibility value at or above a minimum threshold.

In this way, the technical deficiencies of the online job matching are overcome owing to the compatibility match filtering of profile matching job opportunities for only those of the job opportunities scored for compatibility with a job candidate and the moderated promotion of direct, electronic communication between the job candidate and those of the job opportunities determined to be compatible with the job candidate.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of candidate filtering in the electronic matching of job candidates for job interviewing;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for candidate filtering in the electronic matching of job candidates for job interviewing. In accordance with an embodiment of the invention, candidate filtering logic within a host computing platform randomly retrieve different questions from within a repository and transmit the retrieved questions in the form of a Web page or mobile application user interface over a data communications network to a job candidate for rendering within a browser of computing client of the job candidate. The job candidate provides answers to each one of the random questions in the Web page, which answers are returned over the data communications link back to the candidate matching logic of the host computing platform. The candidate filtering logic then immutably stores the answers in association with a pre-established profile of the job candidate in fixed storage.

Thereafter, the candidate filtering logic in the host computing platform executes a comparison operation in memory of the host computing platform in order to compare a combination of the immutably stored answers and the profile to corresponding answers of different employers and respective profiles of the different employers also stored in the fixed storage. From the comparison, the candidate filtering logic computes a compatibility value for each one of the different employers based upon portions of the immutably stored answers and of the profile matching which match respective portions of the corresponding answers and profiles of the different employers. In this regard, one or more points may be awarded for a matching pair of answers to the same question, and one or more points may be deducted from a divergent pair of answers so that the sum of the points awarded and deducted produces a value (but no points will be deducted when an immutably stored one of the answers refers to a question for which no answer exists by a corresponding one of the employers). Finally, the candidate filtering logic triggers a directive to the communications client in the host computing platform to initiate mediated messaging between the job candidate and at least one of the different employers in response to a compatibility value determined to be at or above a minimum threshold.

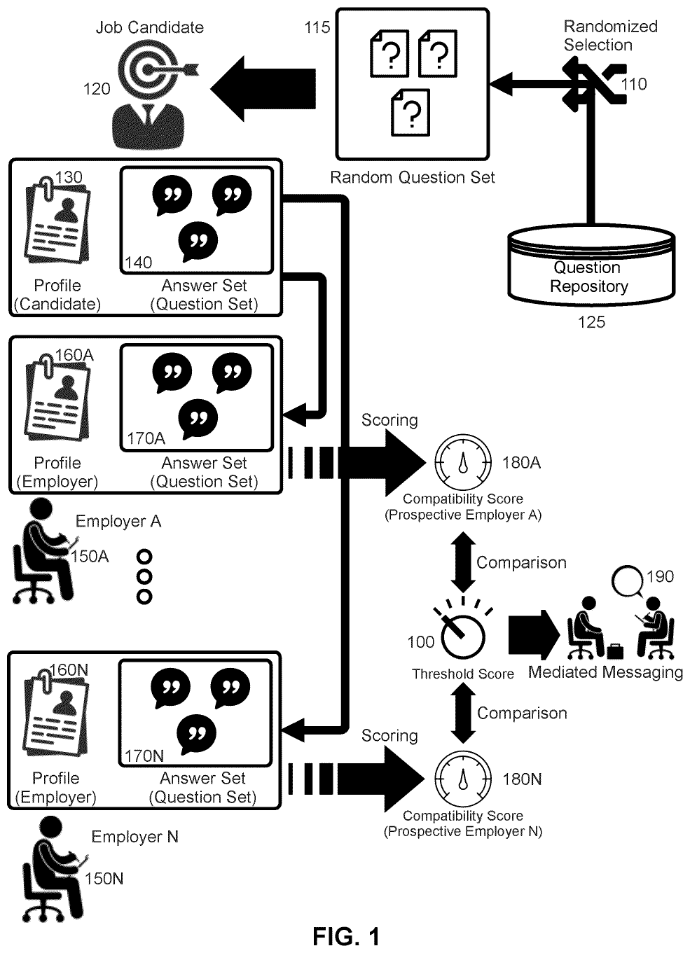

In illustration of one aspect of the embodiment, FIG. 1 pictorially shows a process of candidate filtering in the electronic matching of job candidates for job interviewing. As shown in FIG. 1, a job candidate 120 completes a candidate profile 130 including identifying information regarding the job candidate 120, demographic data regarding the job candidate 120, past positions held by the job candidate 120 and career interests associated with a prospective new job opportunity. Other possibilities include volunteer work, skills, extracurricular activities, to name a few examples. A random question set 115 of questions from a question repository 125 are retrieved by randomization query 110 including multiple choice questions pertaining to personal and professional judgment in response to a presented set of facts. The job candidate 120 answers the multiple choice questions of the random question set 115 in order to produce an answer set 140. Importantly, the job candidate 120 answers the multiple choice questions of the random question set 115 only once and the answer become unchangeable thereafter, e.g. immutable.

The job opportunity profiles 160A, 160N of respective job opportunities 150A, 150N are then compared to the candidate profile 130 in order to produce a subset of the job opportunities 150A, 150N with information matching the information of the profile 130 of the job candidate 120. An answer set 170A, 170N to the same questions of the random question set 115 are retrieved for each of the job opportunities 150A, 150N in the subset and compared to those of the answer set 140. A compatibility score 180A, 180N is then computed for each of the job opportunities 150A, 150N based at least in part upon a number of the answers in the answer set 140 of the job candidate 120 matching the answers of the respective answer sets 170A, 170N of the subset of the job opportunities 150A, 150N.

Each of the compatibility scores 180A, 180N produced for the job opportunities 150A, 150N in the subset are then compared to a threshold score 100 beyond which corresponding ones of the job opportunities 150A, 150N in the subset are considered a prospective candidate match compared to remaining ones of the job opportunities 150A, 150N in the subset. For each corresponding one of the job opportunities 150A, 150N expressing an associated one of the compatibility scores 180A, 180N beyond the threshold score 100, a mediated messaging thread 190 is established prompting either or both of the job candidate 120 and the corresponding one of the job opportunities 150A, 150N to exchange direct messages with one another.

Optionally, to the extent the job candidate 120 is not satisfied with the job opportunities 150A, 150N expressing an associated one of the compatibility scores 180A, 180N beyond the threshold score 100, the job candidate 120 can adjust the information in the candidate profile 130 in order to provoke a different selection of job opportunities 150A, 150N included in the subset. However, the job candidate 120 is unable to change the answers in the answer set 140 as those answers are deemed immutable. However, in one aspect of the embodiment, the job candidate 120 may elect to provide additional answers to additional randomly retrieved questions for addition to the answer set in order to provoke a change in the compatibility scores 180A, 180N.

Even still, in yet another aspect of the embodiment, different temporary instances of the candidate profile 130 can be automatically produced by varying one or more informational elements in the profile 130 in order to produce a what-if analysis so as to produce a set of scenarios of matching ones of the job opportunities 150A, 150N in the subset were the job candidate 120 to change the associated informational elements. The what-if analysis can then be provided to the job candidate 120 to allow the job candidate to consider the implication of changing one or more informational elements in the candidate profile 130.

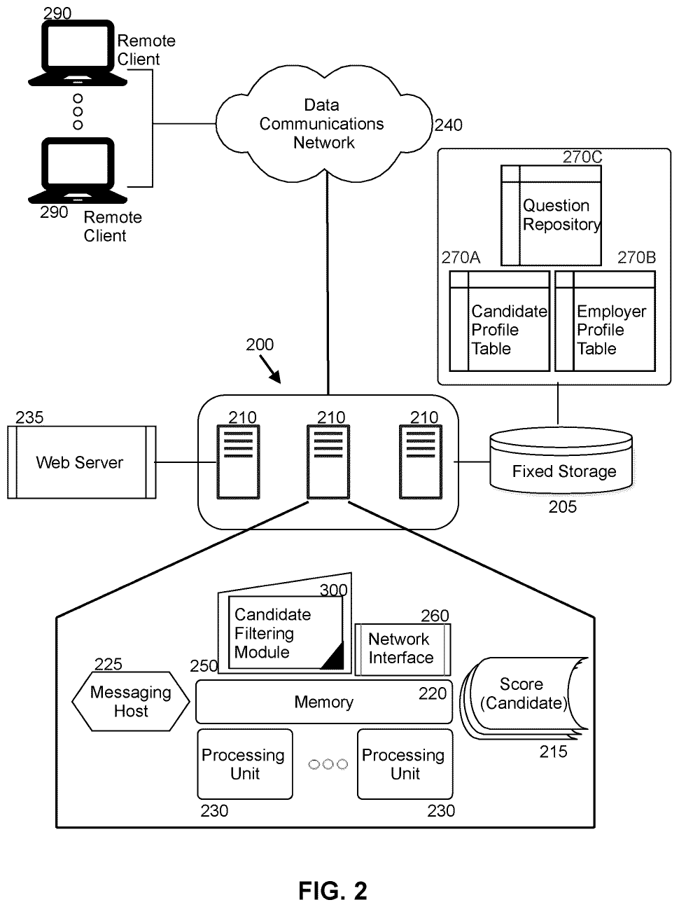

Aspects of the process described in connection with FIG. 1 can be implemented within a data processing system. In further illustration, FIG. 2 schematically shows a data processing system adapted to perform candidate filtering in the electronic matching of job candidates for job interviewing. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Of note, fixed storage 205 is provided in connection with the host computing platform including one or more persistent storage devices and a file system or database system interface through which data can be written to, read from, deleted from and modified within the persistent storage device. To that end, the fixed storage 205 can include different tables 270A, 270B, 270C including a candidate profile table 270A of candidate profiles, an employer profile table 270B of job opportunity profiles, and a question repository 270C of different questions with multiple choice possible answers. As to the question, the questions are those of subjective judgment and lack a “correct” answer and instead include only a discrete set of possible answers.

A Web server 235 also is included within at least one of the computers 210 and is adapted to serve markup language documents to designated remote clients 290 over the data communications network 240 for rendering in a respective Web browser, and to receive in return response strings transmitted by transmitting ones of the remote clients 290 from over the data communications network 240. Of note, the markup language documents can include a randomized selection of the questions from the question repository 270 so that in response to the rendering of one of the markup language documents in a Web browser of hosting one of the remote clients 290 associated with a particular job candidate, a response string is returned to the Web server 235 with the answers to the questions in the markup language document in association with the job candidate.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for candidate filtering in the electronic matching of job candidates for job interviewing. Specifically, the program instructions during execution receive from the Web server 235 in connection with a particular job candidate, a response string to a markup language document containing a random selection of questions from the question repository 270C.

The program instructions then retrieve a candidate profile from the candidate profile table 270A for the particular job candidate and compare the information in the candidate profile to different job opportunity profiles in the employer profile table 270B in order to produce a subset of job opportunities correlating to the candidate profile. Thereafter, the program instructions filter the job opportunities of the subset by comparing the answers in the response string for the random set of questions to those of each of the job opportunities in the subset for the identical set of randomly selected questions. Optionally, different data entries in the candidate profile are included in the comparison. In the course of the comparison, the program instructions then compute a score 215 in the memory 220 for the job candidate in respect to each corresponding one of the job opportunities in the subset.

In this regard, in one aspect of the embodiment, the program instructions apply a positive value for each matching one of the answers and compute a score by summing the positive values. Optionally, the program instructions apply an offsetting value for each divergent one of the answers so that in computing the score, the sum of the positive values is reduced by the offsetting values. As another option, the positive values, and the offsetting values, may be weighted according to the classification of corresponding ones of the questions as set forth in the question repository 270C. As yet another option, the positive value for an answer to a question may be further weighted as a function of the speed at which the job candidate had answered the question, such that an answer to a question provided more quickly than other answers is given a heavier weight.

In another aspect of the embodiment, wherein data entries in the candidate profile are included in the comparison, different ones of the data entries corresponding to different data categories also can be weighted so that certain data elements of certain data categories such as academic performance, or preferred location of employment can be weighted higher than other categories such as benefits or the preferred number of days in the work week.

Finally, the program instructions compare the score 215 for the job candidate in connection with each of the job opportunities in the subset to a pre-determined threshold value so that the job opportunities in the subset with those of the scores 215 falling short of the threshold value are filtered from consideration. Optionally, permissible tolerance value may be specified so that job opportunities in the subset with an associated one of the scores 215 falling short of the threshold value but within the permissible tolerance are not filtered from consideration. The program instructions then transmit directives to a messaging host 225 executing in the host computing platform 200 to initiate corresponding messaging threads between the job candidate and each one of the job opportunities not filtered from the subset.

Specifically, the messaging host 225 includes an endpoint for each of the job candidates with an entry in the candidate profile table 270A. The endpoint can be a user interface control within a markup language document functioning as a profile page for a corresponding one of the job candidates. The endpoint also can be a control with a markup language document functioning as a profile page for a corresponding one of the job opportunities. The directive to the messaging host 225 to initiate corresponding messaging threads between the job candidate and one of the job opportunities, then, is a hypertext transport protocol (HTTP) POST of a textual message in the user interface control of the profile page of the job candidate prompting the job candidate to interact with the one of the job opportunities, the receipt of response text in the user interface control, and the HTTP POST operation of the response text onto the user interface control of the profile page of the one of the job opportunities. Optionally, the response text can be freeform in nature permitting any user text input. But, preferably, the response text is constrained according to a selection of textual input phrases presented in a drop down box so that the job candidate is restricted in the interactivity with the one of the job opportunities.

Notably, in one optional extension of the embodiment, a temporary instance of the candidate profile within the candidate profile table 270A can be generated with one or more varying data entries. The temporary instance of the candidate profile can then be included in the comparison, along with any weighting applied thereto, in order to produce a corresponding what-if score for the temporary instance. As such, the what-if score for the different temporary instance can be compared to the pre-determined threshold value in order to produce a what-if collection of job opportunities. The what-if collection of job opportunities can then be presented in a user interface along with the varying data entries of the temporary instance and those of the data entries which vary from the data entries of the initial candidate profile in the candidate profile table 270A.

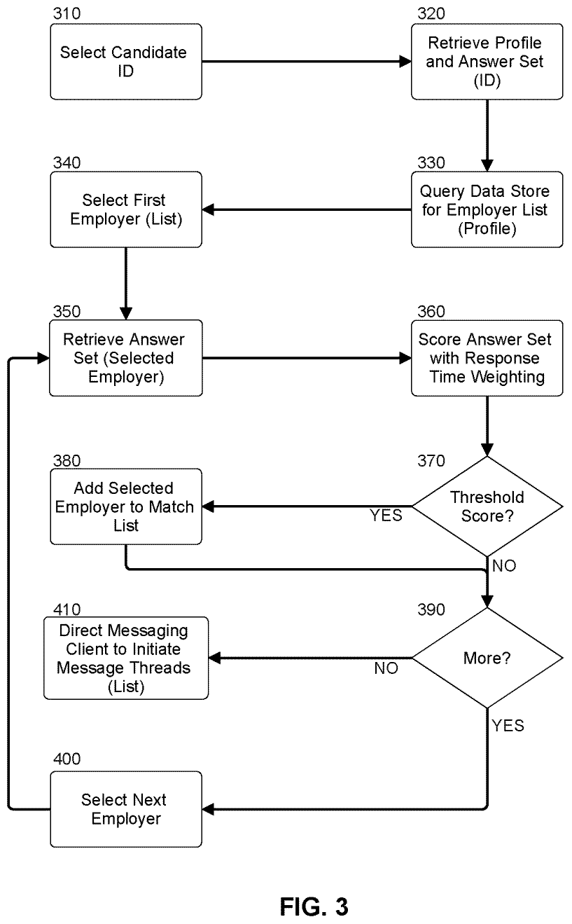

In further illustration of an exemplary operation of the module, FIG. 3 is a flow chart illustrating one of the aspects of the process of FIG. 1. Beginning in block 305, a candidate identifier is determined for a job candidate associated with a response string received from a Web server in connection with the service of a markup language document encapsulating a randomized selection of multiple choice questions. In block 320, a profile is retrieved from fixed storage in respect to the candidate identifier along with an answer set disposed within the response string. Thereafter, in block 330 a query issued against an employer profile table with the candidate profile returns a subset of job opportunities matching the candidate profile.

In block 340, a first opportunity in the subset is selected for processing. In block 350 an answer set to the identical set of questions of the markup language document is retrieved from the fixed storage. The answers of the answer set retrieved in connection with the selected job opportunity are then compared to the answers of the answer set of the response string for the job candidate and a score is computed in block 360. To the extent that the score exceeds a predetermined threshold in decision block 370, the selected job opportunity is added to a filtered list of job opportunities in block 380.

Subsequently, in decision block 390, if additional job opportunities remain to be processed in the subset, the process continues to block 400 with the selection of a next job opportunity in the subset and the process returns to block 350. In decision block 390, when no further job opportunities in the subset remain to be processed, in block 410, a directive is applied to an application programming interface (API) of a direct messaging client to instantiate a message thread for the job candidate for each job opportunity in the filtered list. In this way, direct interactions between the job candidate and the job opportunities of the subset are promoted only for those of the job opportunities associated with a threshold matching of answers to the same randomly selected questions separate and apart from any matching of profiles between the job candidate and the job opportunities of the subset.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A candidate filtering method for electronic matching of job candidates for job interviewing, the method comprising:
configuring a set of markup language documents to include a random selection of questions retrieved from a repository of questions;
transmitting the set of markup language documents to a remote browser of a job candidate and receiving in response to the transmission, response strings corresponding to answers to the random selection of questions;
immutably storing the answers in the response strings in association with a profile of the job candidate;
comparing the immutably stored answers in combination with the profile to corresponding answers of different employers and respective profiles of the different employers;
computing a compatibility value for each one of the different employers based upon portions of the immutably stored answers and of the profile matching which match respective portions of the corresponding answers and profiles of the different employers; and,
initiating mediated messaging between a communications client of the job candidate and at least one of the different employers having a computed compatibility value at or above a minimum threshold.

2. The method of claim 1, further comprising changing data in the profile of the job candidate in order to change the computation of the compatibility for each one of the different employers.

3. The method of claim 1, further comprising initiating mediated messaging with one of the different employers having a computed compatibility value at or above the minimum threshold, but within a deviation value of the minimum threshold.

4. The method of claim 1, further comprising, during computation of the compatibility value, weighting a comparison of one of the immutably stored answers based upon a speed at which the job candidate had provided the one of the immutably stored answers responsive to a presentation of a corresponding one of the random selection of questions.

5. The method of claim 1, further comprising initiating a what-if analysis on changing at least one portion of the profile of the job candidate in order to produce a compatibility value for a specific one of the different employers and transmitting a markup language artifact to the remote browser presenting the changed at least one portion of the profile.

6. A data processing system adapted for candidate filtering in the electronic matching of job candidates for job interviewing, the system comprising:
a host computing platform comprising one or more computers, each with memory and one or more processing units including one or more processing cores;
a Web server executing in the computers and receiving request strings from over a data communications network and responding to the request strings over the data communications network with a transmission of specific ones of markup language documents;
a messaging platform receiving messages and delivering message between different messaging subscribers from over the data communications network;
a database coupled to the platform and providing a repository of question stored therein as different records comprising the questions; and,
a candidate filtering module comprising computer program instructions enabled while executing in the memory of at least one of the processing units of the host computing platform to perform:
configuring a set of the markup language documents in the Web server to include a random selection of questions retrieved from the repository of questions;
directing the Web server to transmit the set of markup language documents over the data communications network to a remote browser of a job candidate and receiving from over the data communications network in response to the transmission, response strings corresponding to answers to the random selection of questions;
immutably storing in the memory the answers in the response strings in association with a profile of the job candidate;
comparing the immutably stored answers in the memory in combination with the profile to corresponding answers of different employers and respective profiles of the different employers;
computing by the one or more of the processing units a compatibility value for each one of the different employers based upon portions of the immutably stored answers and of the profile matching which match respective portions of the corresponding answers and profiles of the different employers; and,
initiating mediated messaging in the messaging platform between a communications client of the job candidate and at least one of the different employers having a computed compatibility value at or above a minimum threshold.

7. The system of claim 6, wherein the program instructions further perform changing data in the profile of the job candidate in order to change the computation of the compatibility for each one of the different employers.

8. The system of claim 6, wherein the program instructions further perform the initiation of the mediated messaging with one of the different employers having a computed compatibility value at or above the minimum threshold, but within a deviation value of the minimum threshold.

9. The system of claim 6, wherein during computation of the compatibility value, the program instructions perform weighting a comparison of one of the immutably stored answers based upon a speed at which the job candidate had provided the one of the immutably stored answers responsive to a presentation of a corresponding one of the random selection of questions.

10. The system of claim 6, wherein the program instructions further perform initiating a what-if analysis on changing at least one portion of the profile of the job candidate in order to produce a compatibility value for a specific one of the different employers and transmitting a markup language artifact to the remote browser presenting the changed at least one portion of the profile.

11. A computing device comprising a non-transitory computer readable storage medium having program instructions stored therein, the instructions being executable by at least one processing core of a processing unit to cause the processing unit to perform candidate filtering for electronic matching of job candidates for job interviewing, by:
configuring a set of markup language documents to include a random selection of questions retrieved from a repository of questions;
transmitting the set of markup language documents to a remote browser of a job candidate and receiving in response to the transmission, response strings corresponding to answers to the random selection of questions;
immutably storing the answers in the response strings in association with a profile of the job candidate;
comparing the immutably stored answers in combination with the profile to corresponding answers of different employers and respective profiles of the different employers;
computing a compatibility value for each one of the different employers based upon portions of the immutably stored answers and of the profile matching which match respective portions of the corresponding answers and profiles of the different employers; and,
initiating mediated messaging between a communications client of the job candidate and at least one of the different employers having a computed compatibility value at or above a minimum threshold.

12. The device of claim 11, wherein the instructions are executable to perform the filtering by further changing data in the profile of the job candidate in order to change the computation of the compatibility for each one of the different employers.

13. The device of claim 11, wherein the instructions are executable to perform the filtering by further initiating mediated messaging with one of the different employers having a computed compatibility value at or above the minimum threshold, but within a deviation value of the minimum threshold.

14. The device of claim 11, wherein the instructions are executable to perform the filtering by weighting, during computation of the compatibility value, a comparison of one of the immutably stored answers based upon a speed at which the job candidate had provided the one of the immutably stored answers responsive to a presentation of a corresponding one of the random selection of questions.

15. The device of claim 11, wherein the instructions are executable to perform the filtering by further initiating a what-if analysis on changing at least one portion of the profile of the job candidate in order to produce a compatibility value for a specific one of the different employers and transmitting a markup language artifact to the remote browser presenting the changed at least one portion of the profile.
